(19) United States
(12) Patent Application Publication
(10) Pub. No.: US 2024/0139878 A1
(43) Pub. Date: May 2, 2024

(54) LASER DEVICES AND METHODS FOR LASER METAL DEPOSITION

(71) Applicant: DIRECTEDMETAL 3D SL., Linares (ES)

(72) Inventor: Lukas Hoppe, Linares (ES)

(21) Appl. No.: 17/977,954

(22) Filed: Oct. 31, 2022

(30) Foreign Application Priority Data
Oct. 28, 2022 (EP) EP22383039.9

(51) Int. Cl. B23K 26/342; B23K 26/03; B23K 26/70

(52) U.S. Cl. CPC B23K 26/342; B23K 26/03; B23K 26/702; B33Y 10/00

(57) ABSTRACT

The present disclosure relates to laser devices for laser metal deposition and methods for laser metal deposition. A laser device for laser metal deposition on a substrate is provided. The laser device comprises a delivery opening for delivering a metallic wire to the substrate, a laser beam source configured to emit a laser beam for fusing the metallic wire with the substrate, and a force sensor for measuring a parameter indicative of a force exerted on the laser device by the metallic wire. The laser device is configured to obtain a first indication related to a distance between the delivery opening and the substrate based on the parameter indicative of a force exerted on the laser device by the metallic wire. Methods for laser metal deposition are also provided.

### FIELD

The present disclosure relates to laser devices for laser metal deposition. The present disclosure further relates to methods for laser metal deposition. The present disclosure further relates to methods and systems for controlling laser metal deposition processes.

### BACKGROUND

Additive manufacturing systems and processes allow the creation of three-dimensional (3D) components from a digital model by adding material, typically layer by layer. For example, computer-aided-design (CAD) software or 3D object scanners may be used to direct a nozzle or a print head of an additive manufacturing system to deposit material on a surface. As the deposited material cools or is cured, depending on the technique used, a 3D object with a specific shape is created.

Some additive manufacturing processes use a laser to melt a feedstock. One type of additive manufacturing process which uses a high-power laser as a heat source is laser metal deposition. In laser metal deposition, the feedstock is metallic, and the feedstock may be provided in powder or wire form. The laser beam heats the substrate and melts it locally, creating a melt pool. The feedstock is supplied to the melt pool and is also melted. The laser beam is usually directed substantially at the interface between the feedstock and the substrate. The melted feedstock is fused to the substrate. Laser metal deposition may e.g. be used for 3D printing or cladding.

The laser metal deposition process may be monitored to check whether the deposited feedstock has a desired quality. For example, in a 3D printing process with laser metal deposition, monitoring may help to check whether a layer, and therefore the 3D object, is being built or has been built correctly.

Different variables may affect the deposition of the feedstock. The printing strategy, the part design, e.g. an envisaged shape and length of the part, and the thermal conditions, influenced e.g. by the power of the laser beam and the temperature of the substrate before being heated by the laser beam, may drastically vary within the part, e.g. within a layer.

For example, if a first layer being built is large or long, the starting portion of the layer, i.e. the portion or the layer which was deposited first, will have had more time to cool down and will be more solid when the next layer is deposited on this starting portion. But if a first layer being built is smaller or shorter, the starting portion of the layer will have had less time to cool down and will be more liquid when the next layer is deposited on the starting portion. The temperature of the first layer, and therefore the more solid or more liquid state of the first layer, may affect one or more operating parameters of the LMD process. For example, the amount of feedstock required for the new layer and/or the required laser power may vary depending on the more solid or more liquid state of the first layer.

Also, a power of an emitted laser beam may affect the more solid or more liquid state of the melt pool when fusing the substrate and the feedstock, and therefore the features of the formed deposit and the part. For example, if the power of the laser beam is too high, the melt pool may be too hot and the melt pool may therefore be too liquid. Accordingly, the material will need more time to cool down and it may spread. The dimensions of the deposit, e.g. its height and width (both measured perpendicularly to the direction of motion of the laser device), may diverge from the desired dimensions. Also, if the power of the laser beam is too high, too much wire may be melted, and this effect may in particular be enhanced if the laser beam is directed more to the wire and less to the substrate. These different phenomena may cause defects in the object.

If the power of the laser beam is too low, the melt pool may be too cold and the melt pool may therefore be excessively solid. Accordingly, the material will need less time to cool down and it will spread less. Again, the dimensions of the deposit may diverge from the desired dimensions. In addition, if the power of the laser beam is too low, an insufficient amount of wire may be melted. This may particularly apply if the laser beam is directed more to the substrate and less to the wire. These are also possible causes for defects in the object. As layer after layer is deposited in 3D printing, any error or deviation during the printing process may on the one hand affect subsequent layers and also defects may be added on top of previous defects.

### SUMMARY

In an aspect of the present disclosure, a laser device for laser metal deposition on a substrate is provided. The laser device comprises a delivery opening for delivering a metallic wire to the substrate, a laser beam source configured to emit a laser beam for fusing the metallic wire with the substrate, and a force sensor for measuring a parameter indicative of a force exerted on the laser device by the metallic wire. The laser device is configured to obtain a first indication related to a distance between the delivery opening and the substrate based on the parameter indicative of a force exerted on the laser device by the metallic wire.

According to this aspect, a laser device comprises a force sensor. Measurements from the force sensor may help to determine an indication related to a distance between the delivery opening and the substrate, e.g. for checking whether a laser metal deposition process may need to be modified. The effect of the state of the melt pool, e.g. a more liquid melt pool or a more solid melt pool may be taken into account for such a check.

A force sensor may herein be regarded as any sensor or measuring system capable of indicating a force exerted on the laser device by the metallic wire. Force sensors may be based on the direct measurement of force, stress or deformation or may be based on measuring one or more other parameters from which the force may be derived.

Throughout the present disclosure, the substrate may herein be regarded as the base or material on which the metallic wire is to be deposited. The substrate may in particular include previously deposited metallic wire, e.g. if a second layer is deposited on a previous first layer.

In some examples, the laser device may further comprise a resistance sensor for measuring a parameter indicative of an electrical resistance between the metallic wire and the substrate. The laser device may further be configured to obtain a second indication related to the distance between the delivery opening and the substrate based on the parameter indicative of an electrical resistance.

A resistance sensor may herein be regarded as any sensor or measuring system capable of indicating an electrical resistance between the metallic wire and the substrate. Resistance sensors may be based on the direct measurement of electrical resistance or may be based on measuring one or more other parameters from which the electrical resistance may be derived.

In some examples, the laser device may be configured to take both the first and the second indication into account. A more reliable monitoring may be performed in this way. In some examples, the laser device may be configured to compare the first indication with the second indication.

In a further aspect of the disclosure, a method for laser metal deposition on a substrate is provided. The method comprises delivering a metallic wire through a delivery opening of a laser device. The method further comprises fusing the metallic wire with the substrate by a laser beam emitted from a laser beam source. The method further comprises measuring a parameter indicative of a force exerted on the laser device by the metallic wire. The method further comprises obtaining a first indication related to a distance between the delivery opening and the substrate based on the parameter indicative of a force exerted on the laser device by the metallic wire.

In some examples, the method may further comprise measuring a parameter indicative of an electrical resistance between the metallic wire and the substrate. The method may further comprise obtaining a second indication related to the distance between the delivery opening and the substrate based on the parameter indicative of electrical resistance.

The first and second indications may be compared.

The laser metal deposition process may be adjusted, e.g. one or more laser metal deposition parameters may be adjusted after detecting a need for adjustment based on the first and/or second indication.

### BRIEF DESCRIPTION OF THE DRAWINGS

FIGS. 1 and 2 illustrate a perspective view and a side view of an example of a laser device, respectively.

FIGS. 3 and 4 illustrate a perspective view and a side view of an example of a schematic mechanical layout of a laser device, respectively.

FIG. 5 schematically illustrates an example of a view of the overlap between three laser beams and the metallic wire projected onto the substrate.

FIG. 6 schematically illustrates an example of a control architecture for the laser beam device of FIGS. 3 and 4.

FIGS. 7 and 8 schematically illustrate examples where a distance between a delivery opening of the laser device and a substrate is above a target distance, and below the target distance, respectively.

FIG. 9 shows an example of a flow chart of a method for laser metal deposition.

### DETAILED DESCRIPTION OF EXAMPLES

Reference now will be made in detail to embodiments of the present disclosure, one or more examples of which are illustrated in the drawings. Each example is provided by way of explanation only, not as a limitation. In fact, it will be apparent to those skilled in the art that various modifications and variations can be made in the present disclosure. For instance, features illustrated or described as part of one embodiment can be used with another embodiment to yield a still further embodiment. Thus, it is intended that the present disclosure covers such modifications and variations as come within the scope of the appended claims and their equivalents.

According to an aspect of the disclosure, a laser device for laser metal deposition on a substrate is provided. The laser device comprises a delivery opening for delivering a metallic wire to the substrate. The laser device further comprises a laser beam source configured to emit a laser beam for fusing the metallic wire with the substrate. The laser device further comprises a force sensor for measuring a parameter indicative of a force exerted on the laser device by the metallic wire. The laser device is configured to obtain a first indication related to a distance between the delivery opening and the substrate based on the parameter indicative of a force exerted on the laser device by the metallic wire.

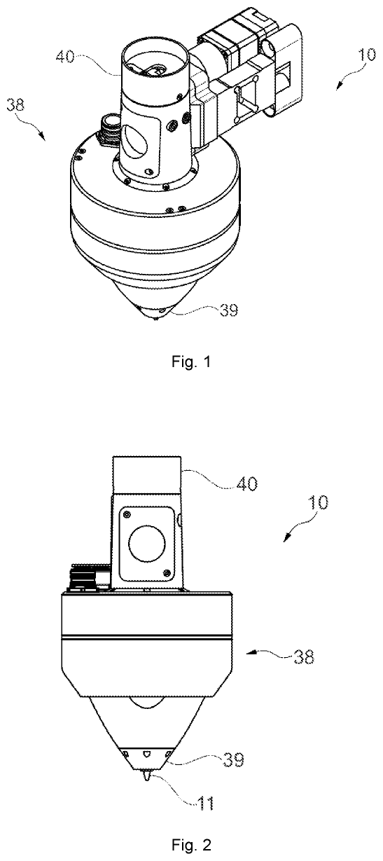

A perspective view and a side view of an example of a laser device 10 are shown in FIGS. 1 and 2, respectively. The laser device 10 may be a print head for a laser metal deposition (LMD) machine or system. The laser device 10 may therefore be relatively compact and usable with one or more different LMD machines or systems (not shown). The laser device 10 may be electrically and mechanically connected to a suitable LMD machine or system, e.g. a robot. The laser device 10 may also be optically connected to the LMD machine or system, e.g. through fiber-optical cable. In other examples, the laser device 10 may be integrated in the LMD machine or system and may not be removable from the LMD machine or system. The laser device 10 may operate in an open-air or in an inert atmosphere environment.

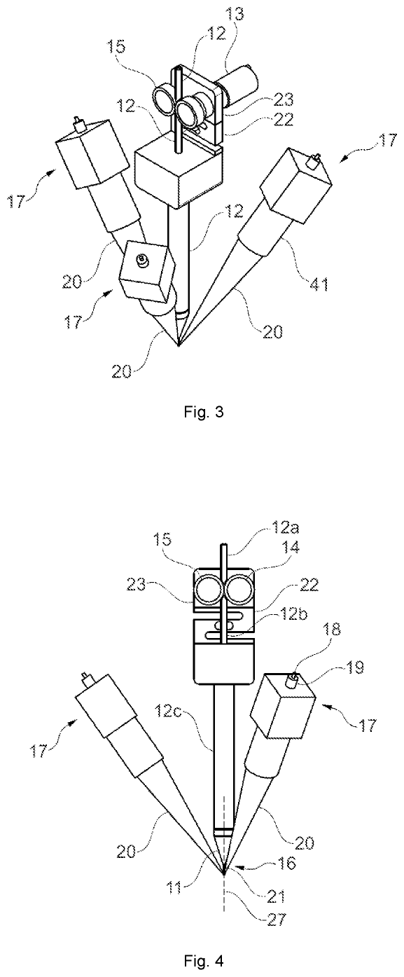

The laser device 10 may comprise multiple internal channels (not shown) for providing coolant and/or shield gas besides a metallic feedstock. In some examples, a metallic wire may be provided through a guide tube 12, see e.g. FIG. 3. The laser device 10 may further comprise collimation and focusing optics 41, see e.g. FIG. 3.

The laser device 10 may comprise a housing 38 enclosing one or more laser beam sources, a guide tube for the metallic wire and other components such as collimation and focusing optics (for one or more of the laser beam sources), coolant and/or shield gas channels. The laser device 10 may comprise a nozzle cowling 39 in some examples. The nozzle cowling 39 may be removable and, in examples where shield gas is used, the nozzle cowling 39 may help to distribute the shield gas. A shield gas may e.g. be argon, nitrogen or a mixture of gases. A shield gas may include gases that are consumed in the process.

The housing 38 may comprise a coupling neck 40 for connecting and disconnecting the laser device 10 to a LMD machine or system. Connection may e.g. be mechanical and electrical. Connection may also be optical, e.g. through fiber-optical cable. The coupling neck 40 may allow the laser device 10 to be coupled to coolant and/or shield gas supply lines. In some examples, the coupling neck 40 may allow the laser device 10 to be coupled to a metallic wire line.

A nozzle 11 for delivery of metallic wire is provided substantially along a central longitudinal axis of the laser device 10. In some examples, a metallic wire is fed along the central longitudinal axis.

In some examples, the laser device 10 may include a plurality of off-axis laser beam sources. For example, 6 or 9 or any other suitable number of laser beam sources may be used. In some examples, the laser beam sources may all be the same, emitting laser beams (or configured to emit laser beams) of the same wavelength and with the same power. In other examples, different laser beam sources may be combined. The plurality of laser beam sources may have a substantially common focal point. In a laser metal deposition process, the common focal point may be at or near the interface between the metallic feedstock and the substrate. The points of intersection of the plurality of laser beams at the interface of substrate and feedstock may be directly adjacent to each other. The points of intersection may be regularly distributed along an imaginary 360° circle.

A perspective view and a side view of an example of a schematic mechanical layout of a laser device 10 are shown in FIGS. 3 and 4 respectively. The laser device may be the laser device shown in FIGS. 1 and 2, for example. The housing of the laser device is omitted in these figures for more clearly showing the elements of the laser device 10 relevant for this disclosure.

The laser device 10 of the examples of FIGS. 3 and 4 comprises a wire spool (not shown) around which a metallic wire is wound. In other examples, the wire spool may be provided outside the laser device. The metallic wire in this example enters a wire guide tube 12. The wire spool may be arranged above or besides the top end of the wire guide tube 12. The wire guide tube 12 is configured to guide the metallic wire towards a nozzle 11.

The wire guide tube 12 may comprise a plurality of portions. The example of FIGS. 3 and 4 illustrates three parts of the guide tube 12: a top part 12a, a middle part 12b and a bottom part 12c. There is a gap between the top part 12a and the middle part 12b. The laser device 10 further comprises a wire feed motor 13 and a wire drive wheel 14 operatively connected to the wire feed motor 13 for causing the metallic wire to move towards the nozzle 11. The laser device 10 comprises a wire idler wheel 15 configured to force the metallic wire into contact with wire drive wheel 14 to aid in feeding the metallic wire. The wire drive wheel 14 may contact the metallic wire 21 substantially between the top part 12a and the middle part 12b of the wire guide tube 12. The nozzle 11 is coupled with the wire guide tube 12. The nozzle 11 comprises a delivery opening 16 through which the metallic wire 21 is supplied.

The laser device 10 of this example further comprises a plurality of laser beam sources 17, in particular three laser beam sources 17. In other examples, the laser device 10 may comprise one, two, four or any other suitable number of laser beam sources, e.g. six or nine laser beam sources. In the example of FIGS. 3 and 4, the laser beam sources 17 are fiber coupled lasers. The laser beam sources 17 comprise a laser fiber connector 19 to which a laser fiber 18 can be connected. In other examples, the laser beam sources may be direct diode lasers (i.e. fiber-free lasers), e.g. solid state diode lasers or diode pumped solid state lasers. The laser beam sources 17 may include laser collimating and focusing optics 41.

In some examples, all the laser beam sources 17 may be configured to emit a laser beam within a same wavelength range, e.g. between 800 and 900 nm. In other examples, different laser beam sources 17 may be configured to emit laser beams in different or partially overlapping wavelength ranges. For instance, one or more laser beam sources 17 may be configured to emit laser beams in a wavelength range of e.g. 850 to 900 nm whereas one or more other laser beam sources 17 may be configured to emit laser beams in a wavelength range of e.g. between 800 and 850 nm. Other wavelength ranges may also be used. A suitable wavelength range may depend inter alia on the material used, e.g. the metal alloy of the feedstock.

In some examples, the one or more laser beam sources 17 may be configured as insertable laser beam sources. I.e., the laser beam sources 17 may be arranged and secured within suitable openings or receptacles of the laser device 10. The housing 38 may then cover the laser beam sources 17.

The laser device 10 of the example of FIGS. 3 and 4 schematically illustrates the laser beam sources 17 emitting laser beams 20. The laser device 10 is configured such that the laser beams 20 converge on the metallic wire supplied through the delivery opening 16 of the nozzle 11, preferably substantially at an interface between the wire and the substrate, such that a portion of the energy is directed to the substrate for melting the substrate and creating a weld pool, and a portion of the energy is directed to wire for melting the wire.

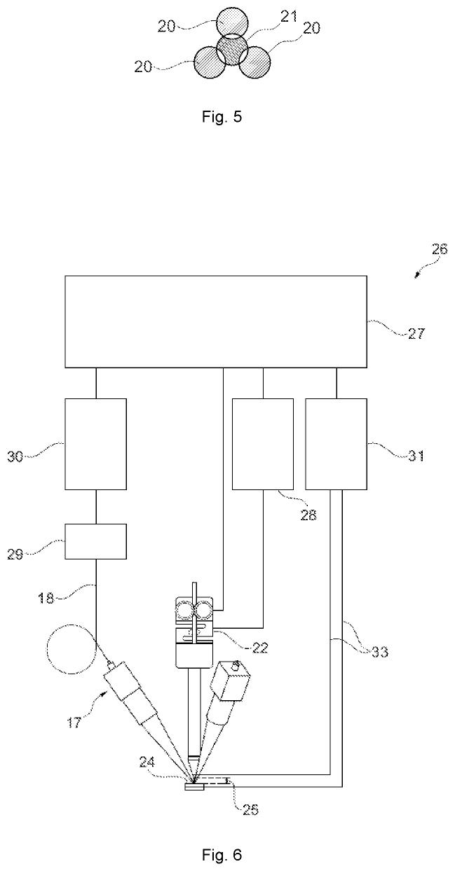

FIG. 5 schematically shows an example of a view of the overlap between the laser beams 20 and the metallic wire 21 projected onto the substrate. Each of the three laser beams 20 is impinging on a wire end portion, in particular on a wire tip portion, for melting the wire and fusing it with the substrate.

The laser beam source(s) 17 may be off-axis laser beam source(s) spaced, e.g. regularly spaced, about a longitudinal central axis 27 of the laser device 10, see e.g. the example of FIG. 3. Off-axis herein refers to the laser beams not being parallel to the longitudinal central axis of the laser device and the wire.

The laser device 10 further comprises a force sensor 22 for measuring a parameter indicative of a force of the metallic wire 21 exerted on the laser device 10. When the metallic wire 21 is fed for melting the wire with the substrate, the wire exerts a force on the substrate (and vice versa, the substrate exerts a force on the wire). A force exerted by the metallic wire on the laser device 10, e.g. on a wire feed system including the wire feed motor 13 and a wire drive wheel 14, may be a suitable proxy for the interaction force between the metallic wire and the substrate. The force sensor 22 may measure force, weight, torque, pressure, tension or other suitable force-related parameter. The force sensor 22 may be a load cell in some examples. The force sensor 22 may be a strain gauge, a force sensing resistor or a torque sensor in other examples. For instance, the laser device 10 may comprise a torque sensor (not shown) for measuring torque of the wire feed motor 13. Torque of the motor may also be determined in examples by measuring the currents in the motor.

An example wherein the force sensor 21 is a load cell is illustrated in the example of FIGS. 3 and 4. The laser device 10 of this example further comprises a support 23 for the wire drive wheel 14, the wire feed motor 13 and the wire idler wheel 15. The load cell is attached to the support 23, e.g. below it. In this manner, the load cell may be capable of measuring the force of the metallic wire 21 on the laser device as there is a connection between the metallic wire 21 and the load cell 21 via e.g. the wire drive wheel 14 and the support 23. The load cell, or in general a force sensor, may be arranged in other suitable locations in other examples.

The type of load cell or force sensor may e.g. be varied depending on the location where the load cell is to be arranged. For instance, a wire load cell configured to receive a metallic wire 21 may be arranged e.g. between the top part 12a of the guide tube 12 and the wire feed motor 13. The metallic wire 21 may go through the wire load cell and the wire load cell may measure the tension force of the metallic wire 21.

In these or other examples, the laser device 10 may be configured to calculate a force that the metallic wire 21 exerts on the laser device 10. For instance, if force is not measured directly (e.g. pressure, weight or torque may be measured), a force value may be calculated by the laser device 10 from a measured value (e.g. from the measured pressure, weight or torque).

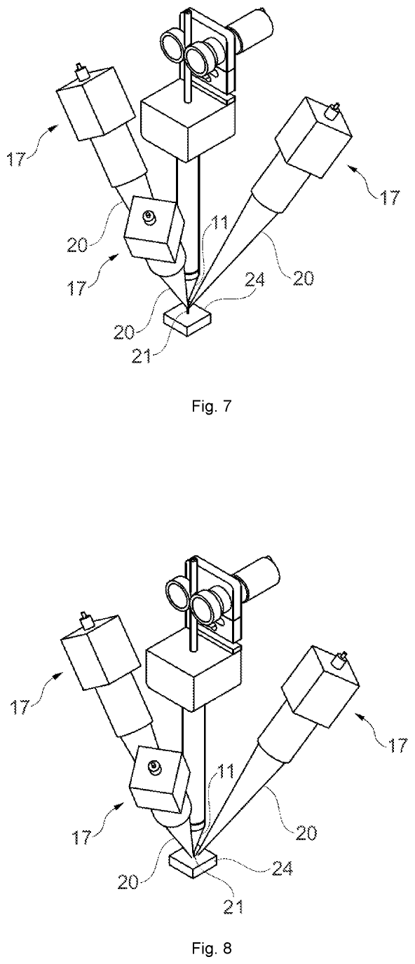

FIG. 6 schematically illustrates an example of a control architecture 26 for the laser beam device 10, e.g. for the laser beam device 10 of the example of FIGS. 3 and 4. The straight lines refer to connections between two components. The laser device 10 comprises, in this example, a controller 27, e.g. a main controller. The controller 27 may comprise one or more processor and one or more memories. The one or memories may comprise instructions that, when executed by one or more of the processors cause the one or more processors to perform one or more actions, e.g. sending one or more control signals for controlling a laser metal deposition process.

The controller 27 is electrically connected to a force sensor programmable logic controller (PLC) 28 and to the wire feed motor 13. The force sensor PLC 28 is connected to the force sensor 22. The force sensor PLC is configured to receive measurements from the force sensor 22. The force sensor PLC 28 is also configured to send data, e.g. measurements from the force sensor 22, to the controller 27. The controller 27 is configured to analyze the data received from the force sensor PLC 28. Based on this data, the controller 27 may obtain a first indication related to a distance 25 between the delivery opening 16 and the substrate 24. In some examples, the laser device 10, e.g. the controller 27 thereof, may be configured to determine a distance 25 between the delivery opening 16 of the laser device and the substrate 24.

In examples, the controller may convert a measured force to a distance using a look-up table. Depending on the type of sensor, the look-up table may include different values for a measured variable (force, stress, elongation, torque, currents or otherwise) and correlate these values with a distance. The look-up table may be stored e.g. in a memory of controller 27.

In other examples, the controller 27 may calculate the distance based on the measured variable using one or more predefined equations.

Based on an indication related to the distance 25, e.g. a calculated distance 25, the controller 27 may be configured to adjust one or more parameters of a laser metal deposition process. In particular, an adjustment may be made if the calculated distance 25 deviates from a target distance, and more particularly if the calculated distance 25 deviates from a target distance by more than a predetermined threshold. For example, the controller 27 may be configured to send control signals to the wire feed motor 13. If the laser metal deposition process occurs according to the original design and plan, control signals may be sent to ensure normal continuation of the process. If a deviation is found, adjusted signals may be sent to correct and/or avoid defects.

The controller 27 in this example is also configured to control one or more laser beam sources 17. In the example of FIG. 6, the laser fiber 18 is electrically, mechanically and optically connected to a laser diode 29. As explained previously, fiber-free laser beam sources may be used in other examples. A laser driver 30 is provided between the controller 27 and the laser diode 32. In other examples, a laser device PLC (not shown) may be provided, e.g. between the controller 27 and the laser driver 30. In some examples, the controller 27 may be configured to send a control signal to the laser beam source 17, e.g. to adjust the power of a laser beam 20 emitted by the laser beam source 17.

Accordingly, the controller 27 is able to control the operation of the laser device 10 based on an indication related to a distance 25 between the delivery opening 16 of the laser device 16 and the substrate 24. The indication related to the distance 25 between the delivery opening 16 of the laser device 10 and the substrate 24 is based on a force of the metallic wire 21 exerted on the laser device 10. The delivery opening 16 may be in a nozzle 11 of the laser device 10.

In some examples, the laser device 10 may further comprise a resistance sensor 33 for measuring a parameter indicative of an electrical resistance between the metallic wire 21 and the substrate 24. The laser device 10 may be further configured to obtain a second indication related to the distance 25 between the delivery opening 16 and the substrate 24 based on the parameter indicative of an electrical resistance. In some examples, the parameter indicative of an electrical resistance may be an electrical resistance. I.e., an electrical resistance may be measured. In other examples, other parameters from which electrical resistance may determined may be measured instead.

For example, the laser device 10 may be configured to measure a parameter indicative of an electrical resistance between a point on the nozzle 11 and the substrate 24. An example of this arrangement is schematically illustrated in the example of FIG. 6A first electrical wire may be connected to the nozzle 11, and a second electrical wire may be connected to the substrate. In other examples, the wire may be configured to be connected (or may already be connected) to the guide tube 12.

A closed electric circuit is formed between the nozzle 11, the metallic wire 21, the substrate 24 and a power source (not shown). The laser device 10 may further comprise a power source for providing a voltage, i.e. an electric potential difference, between the wires of the substrate and the nozzle (in this example). A current will flow as a result of the voltage, and the current may be measured. The measured current may be used for calculating an electrical resistance between the metallic wire 21 and the substrate 24. The resistance sensor 33 may measure such current.

The laser device 10 may further comprise a resistance sensor PLC 31. The resistance sensor PLC 31 may be connected to the controller 27 and to the resistance sensor 33, e.g. to the first and second electrical wires. The controller 27 may be configured to obtain the second indication related to the distance 25 between the delivery opening 16 and the substrate 24.

Based on the first and/or second indications, the controller 27 may send one or more control signals, e.g. for controlling a power of one or more laser beams 20 and/or a signal to control a speed at which the metallic wire 21 is supplied.

In some examples, the laser device may be configured to compare the first indication and the second indication. Comparing may help to know if the laser metal deposition process may need some modification or correction in a more reliable manner. FIGS. 7 and 8 schematically illustrate examples where a distance 25 between the delivery opening 16 and the substrate 24 is above a target distance, and below the target distance, respectively.

If the distance 25 between the delivery opening 16 and the substrate 24 is above the target distance, as in the example of FIG. 7, the laser beams 20 may melt a portion of the metallic wire 21 which does not contact the substrate 24. The force exerted by the metallic wire 21 on the laser device 10 may decrease and the electrical resistance between the metallic wire 21 and the substrate 24 may increase.

If the distance 25 between the delivery opening 16 and the substrate is below the target distance, as in the example of FIG. 8, the laser beams 20 may not melt or barely melt the metallic wire 21. The force exerted by the metallic wire 21 on the laser device 10 may increase and the electrical resistance between the metallic wire 21 and the substrate 24 may decrease.

The laser device 10 may be configured to discard the first indication or the second indication, or in certain circumstances rely more on the first indication than on the second indication or vice versa. It has been observed that if the distance 25 is too small, the resistance sensor 33 may provide inaccurate or less reliable measurements. In a range of distances, the resistance will not vary a lot even if the distance changes. Therefore, if such a situation is detected by the laser device 10, the second indication may be discarded, or the first indication may be given more weight than the second indication. For example, only the first indication may be used if the electrical resistance data is not deemed sufficiently accurate or reliable.

It has also been observed that if the distance 25 is too large, the force sensor 22 may provide inaccurate or less reliable measurements as the force may be excessively low. Above a certain distance threshold, the measured force will hardly vary anymore with increased distance. Therefore, if such a situation is detected by the laser device 10, the first indication may be discarded, or the second indication may be given more weight than the first indication. For example, only the second indication may be used if the force data is not deemed sufficiently accurate or reliable.

Combining both an electrical resistance sensor and a force sensor thus can significantly improve reliability of the measurements, particularly at the lower end and the upper end of the measured distance.

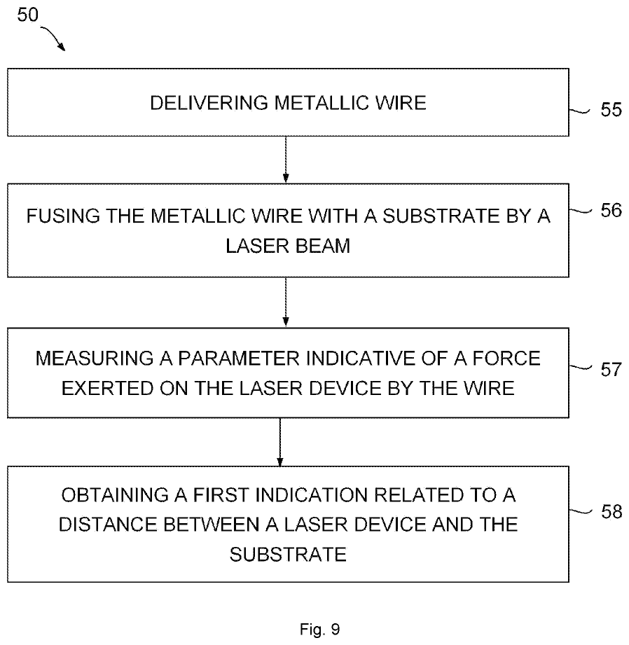

According to a further aspect of the disclosure, a method 55 for laser metal deposition on a substrate 24 is provided. The method is schematically shown in the flow chart of FIG. 9. The laser device 10 described hereinbefore may be used to perform the steps of this method.

The method comprises, at block 56, delivering a metallic wire 21 through a delivery opening 16 of a laser device 10. The method further comprises, at block 57, fusing the metallic wire 21 with the substrate 24 by a laser beam 20 emitted from a laser beam source 17. The method further comprises, at block 58, measuring a parameter indicative of a force exerted on the laser device by the metallic wire 21. The method further comprises, at block 59, obtaining a first indication related to a distance 25 between the delivery opening 16 and the substrate 24 based on the parameter indicative of a force exerted on the laser device 10 by the metallic wire 21.

In some examples, the method may further comprise measuring a parameter indicative of an electrical resistance between the metallic wire 21 and the substrate 24, and obtaining a second indication related to the distance 25 between the delivery opening 16 and the substrate 24 based on the parameter indicative of an electrical resistance. A resistance sensor 33 may for instance be used.

The first indication may be compared with the second indication in some examples. A decision of modifying the laser metal deposition process may be more reliable by comparing the first and second indications.

In some examples, if the parameter indicative of an electrical resistance, e.g. an electrical resistance, is below an electrical resistance threshold, the method may further comprise discarding the second indication. The electrical resistance threshold may be known in advance. For example, the laser device 10 may be calibrated to find and define a suitable electrical resistance threshold. The resistance threshold may be indicative of an excessively small distance 25. I.e., measurements of electrical resistance below the resistance threshold may be insufficiently accurate and they may be discarded or deemed less reliable. Measurements from the force sensor 22 may be used instead for analyzing whether the laser metal deposition process should be modified.

Similarly, in some examples, if the parameter indicative of a force is above a force threshold, the method further may further comprise discarding the first indication. This force threshold may be known in advance. For example, the laser device 10 may be calibrated to find and define a suitable force threshold. The force threshold may be indicative of an excessively big distance 25. I.e., measurements of a parameter indicative of a force below the force threshold may be insufficiently accurate and they may be discarded. Measurements from the resistance sensor 33 may be used instead for analyzing whether the laser metal deposition process should be modified.

In some examples, the method may further comprise determining a distance 25 between the delivery opening 16 of the laser device 10 and the substrate 24 based on the first indication and/or the second indication. A controller 27 of the laser device 10 may calculate such distance.

The method may further comprise comparing the determined distance between the delivery opening 16 and the substrate 24 to a target distance between the delivery opening and the substrate. This comparison may help to check whether some modification or correction of the laser metal deposition process is required.

Irrespective of whether one or two indications are obtained, the method may further comprise adjusting one or more laser metal deposition parameters in case the determined distance deviates fore than a threshold value from the target distance.

Adjusting may comprise adjusting one or more of the following parameters: a power with which the laser beam source emits a laser beam, a speed at which the metallic wire is delivered, a speed at which the laser device is moved relative to the substrate, and a distance between the substrate and the opening through which the metallic wire is delivered.

If laser metal deposition is performed with a hot wire, the current passed through the wire may additionally or alternatively be adjusted.

If a laser device 10 comprises more than one laser beam source 17, the power of the laser beam to be emitted may be adjusted independently for each laser beam source 17 in some examples.

In some examples, instead of performing adjustments during the laser metal deposition process, the method may further comprise building a digital twin based on the first indication and/or the second indication. A digital twin may be understood as virtual replica of the manufactured object. I.e., an object may be first manufactured. The first indication and/or the second indication may be used for simulating a 3D printing process and for building a virtual 3D model which corresponds to the physically printed object. As the printed object may have suffered undesired distortions during the laser metal deposition process, this can be verified by an analysis of the virtual model, i.e. the digital twin. The digital twin may allow to digitally analyze the printed object and identify which distortions have occurred in the actual printing process and also wherein defects or distortions have occurred. The analysis of the digital twin may then be used to modify the 3D model input file which directs the laser metal deposition process. An improved 3D printed object may accordingly be obtained, as the previously observed distortions may be avoided with the modified 3D model input file. Trial and error testing may also be reduced with the help of the digital twin.

Although in the examples shown in the figures of this disclosure, the metallic feedstock is provided through the longitudinal central axis 27 of the laser device 10 and the one or more laser beam sources 17 are off-axis sources, i.e. they are angled with respect to the longitudinal central axis 27 for emitting laser beams which contact the metallic feedstock and the substrate at a focal point, other arrangements of metallic feedstock and laser beam sources 17 are possible. For example, a metallic wire may be provided off-axis (i.e. angled with respect to the longitudinal central axis 27 of the laser device 10) whereas a laser beam source 17 may be configured to emit a laser beam 20 substantially parallel to the longitudinal central axis 27 of the laser device 10.

This written description uses examples to disclose a teaching, including the preferred embodiments, and also to enable any person skilled in the art to put the teaching into practice, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application. If reference signs related to drawings are placed in parentheses in a claim, they are solely for attempting to increase the intelligibility of the claim, and shall not be construed as limiting the scope of the claim.

1. A laser device for laser metal deposition on a substrate, the laser device comprising:
a delivery opening for delivering a metallic wire to the substrate;
a laser beam source configured to emit a laser beam for fusing the metallic wire with the substrate;
a force sensor for measuring a parameter indicative of a force exerted on the laser device by the metallic wire; and
wherein the laser device is configured to obtain a first indication related to a distance between the delivery opening and the substrate based on the parameter indicative of a force exerted on the laser device by the metallic wire.

2. The laser device of claim 1, wherein the force sensor is a load cell.

3. The laser device of claim 1, further comprising a resistance sensor for measuring a parameter indicative of an electrical resistance between the metallic wire and the substrate, and wherein the laser device is further configured to obtain a second indication related to the distance between the delivery opening and the substrate based on the parameter indicative of an electrical resistance.

4. The laser device of claim 3, wherein the laser device further comprises a guide tube for guiding the metallic wire towards the delivery opening, and wherein the laser device is configured to measure the electrical resistance between the guide tube and the substrate.

5. The laser device of claim 3, wherein the laser device further comprises a nozzle for supplying the metallic wire to the substrate, and wherein the laser device is further configured to measure the electrical resistance between the nozzle and the substrate.

6. The laser device of claim 3, wherein the laser device is configured to compare the first indication with the second indication.

7. The laser device of claim 1, wherein the laser device is a print head.

8. A method for laser metal deposition on a substrate, the method comprising:
delivering a metallic wire through a delivery opening of a laser device;
fusing the metallic wire with the substrate by a laser beam emitted from a laser beam source;
measuring a parameter indicative of a force exerted on the laser device by the metallic wire; and
obtaining a first indication related to a distance between the delivery opening and the substrate based on the parameter indicative of a force exerted on the laser device by the metallic wire.

9. The method of claim 8, further comprising:
measuring a parameter indicative of an electrical resistance between the metallic wire and the substrate; and
obtaining a second indication related to the distance between the delivery opening and the substrate based on the parameter indicative of an electrical resistance.

10. The method of claim 9, further comprising comparing the first indication with the second indication.

11. The method of claim 9, wherein if the parameter indicative of electrical resistance is below an electrical resistance threshold, the method further comprises discarding the second indication.

12. The method of claim 11, wherein if the parameter indicative of a force is below a force threshold, the method further comprises discarding the first indication.

13. The method of claim 9, wherein if the parameter indicative of a force is below a force threshold, the method further comprises discarding the first indication.

14. The method of claim 9, further comprising determining a distance between the delivery opening and the substrate based on the first indication and/or the second indication.

15. The method of claim 14, further comprising comparing the determined distance between the delivery opening and the substrate to a target distance between the delivery opening and the substrate.

16. The method of claim 15, further comprising adjusting one or more laser metal deposition parameters in case the determined distance deviates more than a threshold value from the target distance.

17. The method of claim 16, wherein adjusting comprises adjusting one or more of the following parameters: a power with which the laser beam source emits a laser beam, a speed at which the metallic wire is delivered, a speed at which the laser device is moved relative to the substrate and a distance between the substrate and the opening through which the metallic wire is delivered.

18. The method of claim 9, further comprising building a digital twin based on the first indication and/or the second indication.
